(19) United States
(12) Patent Application Publication
(10) Pub. No.: US 2025/0391160 A1
(43) Pub. Date: Dec. 25, 2025

(54) METHOD AND APPARATUS FOR MULTI-TASK PREDICTION, ELECTRONIC DEVICE AND STORAGE MEDIUM

(71) Applicant: Beijing Zitiao Network Technology Co., Ltd., Beijing (CN)

(72) Inventor: Dengke DONG, Beijing (CN)

(21) Appl. No.: 18/881,233

(22) PCT Filed: Jun. 29, 2023
(86) PCT No.: PCT/CN2023/103755

§ 371 Date: Jan. 3, 2025

(30) Foreign Application Priority Data
Jul. 4, 2022 (CN) 202210785776.3

(51) Int. Cl. G06V 10/776; G06V 10/764; G06V 10/82; G06V 40/20

(52) U.S. Cl. CPC G06V 10/776; G06V 10/764; G06V 40/28; G06V 10/82

(57) ABSTRACT

The embodiment of the disclosure discloses a method of multi-task prediction and device, electronic equipment and a storage medium, and the method comprises the steps: inputting an original image into a preset model; outputting a prediction result of at least one prediction task for the original image through the preset model, wherein the at least one prediction task comprises a key point prediction task; the loss item of the preset model in the training process comprises a first loss constructed according to the error distribution between the first prediction result of the key point prediction task and the key point position label.

This application claims the benefit of Chinese Patent Application No. 202210785776.3, filed on Jul. 4, 2022, which is hereby incorporated by reference in its entirety.

### FIELD

the embodiment of the disclosure relates to the technical field of computers, in particular to a method and apparatus for multi-task prediction, electronic device and a storage medium.

### BACKGROUND

Multi-task learning may refer to the method of joint training of multiple tasks by using the useful information in related but different tasks. In the process of multi-task learning, the reasonable construction of multi-task loss has an important impact on the training effect.

In a case where the multi-task includes the key point prediction task, the existing loss is used to perform regression training on the model, the training effect of the model is not guaranteed, and the situation that joint training fails is easy to occur, so that the accuracy of multi-task prediction is directly influenced.

### SUMMARY

The embodiment of the disclosure provides a method and apparatus for multi-task prediction, electronic device and a storage medium, which can realize multi-task joint training including key point prediction tasks and has good training effect and therefore the accuracy of multi-task prediction can be ensured.

According to a first aspect, embodiments of the present disclosure provide a method of multi-task prediction, including:
Inputting an original image into a predetermined model;
Outputting a prediction result for at least one prediction task of the original image by the predetermined model;
The at least one prediction task comprises a key point prediction task, and wherein the loss item of the predetermined model in the training process comprises a first loss constructed based on an error distribution between the first prediction result of the key point prediction task and the key point position label.

In a second aspect, embodiments of the present disclosure further provides an apparatus for a multi-task prediction including:

An input module, configured to input the original image into a predetermined model.

An output module, configured to output a prediction result for at least one prediction task of the original image by the predetermined model;

The at least one prediction task comprises a key point prediction task, and wherein the loss item of the predetermined model in the training process comprises a first loss constructed based on an error distribution between the first prediction result of the key point prediction task and the key point position label.

According to a third aspect, embodiments of the present disclosure further provides an electronic device, including:
At least one processor;
A storage device configured to store at least one program,
when the at least one program is executed by the at least one processor, cause the at least one processor to implement the method of the multi-task prediction according to any of the embodiments of the present disclosure.

According to a fourth aspect, embodiments of the present disclosure further provides A readable storage medium comprising a computer program, wherein the computer program, when executed by a computer processor, performs the method of the multi-task prediction according to any of the embodiments of the present disclosure.

### BRIEF DESCRIPTION OF DRAWINGS

FIG. 1 is a schematic flowchart of a method of multi-task prediction according to embodiments of the present disclosure;

FIG. 2 is a schematic flowchart of a training step of a preset model in a method of multi-task prediction according to embodiments of the present disclosure;

FIG. 3 is a schematic block diagram of a preset model training step in a method of multi-task prediction according to embodiments of the present disclosure;

FIG. 4 is a schematic structural diagram of an apparatus for multi-task prediction according to embodiments of the present disclosure;

FIG. 5 is a schematic structural diagram of an electronic device according to embodiments of the present disclosure.

### DETAILED DESCRIPTION

In the description of embodiments of the present disclosure, the term “comprise(s)” and similar terms shall be understood as open inclusion, that is, “including but not limited to”. The term “based on” is to be understood as “based at least in part on”. The term “one embodiment” is to be understood as “at least one embodiment”. The term “a further embodiment” is to be understood as “at least further embodiment”. Other explicit and implicit definitions may also be comprised below.

It should be noted that concept concepts such as “first” and “second” mentioned in this disclosure are merely used to distinguish different apparatuses, modules, or units.

It should be noted that the modification of “a” and “a plurality” mentioned in this disclosure is illustrative, and those skilled in the art should understand that “one or more” should be understood unless the context clearly indicates otherwise.

It is to be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

It may be understood that the data involved in the technical solution (including the data itself, the acquisition or use of the data) should follow the requirements of the corresponding laws and regulations and related regulations.

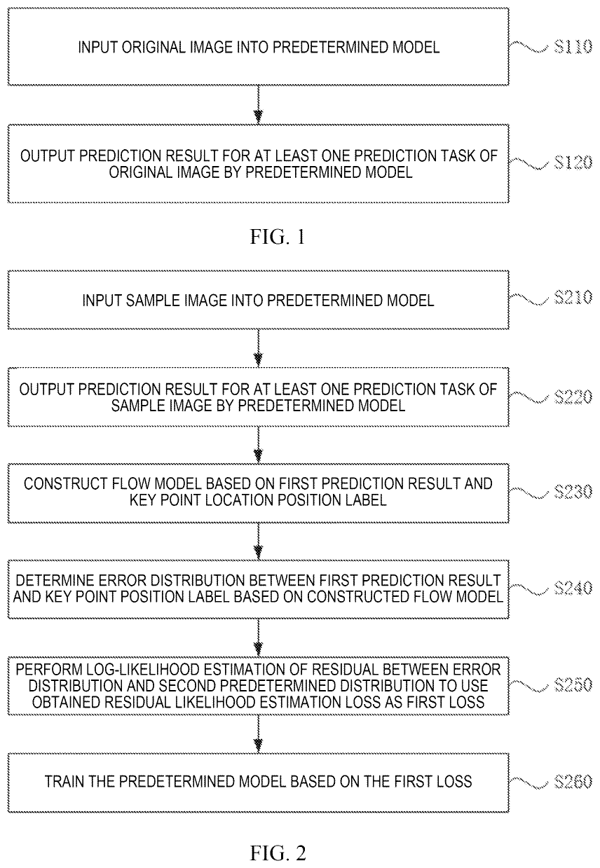

FIG. 1 is a schematic flowchart of a method of multi-task prediction according to embodiments of the present disclosure. The embodiments of the disclosure is suitable for the situation that the image is subjected to multi-task prediction through a preset model, wherein the multi-task comprises a key point prediction task, and the preset model is obtained through training based on the real error distribution of the key point prediction task. The method may be performed by an apparatus for multi-task prediction, and the apparatus may be implemented in at least one of software and hardware, and the apparatus may be configured in an electronic device, for example, configured in a device such as a mobile phone or a computer.

As shown in FIG. 1, the method of multi-task prediction provided in the embodiments may include the following steps.

S110: Inputting an original image into a predetermined model;

S120: Outputting a prediction result for at least one prediction task of the original image by the predetermined model.

In this embodiment, the original image can be an image obtained in accordance with the requirements of relevant laws and regulations. The preset model can be a neural network model, which can be used for prediction of at least one task of the original image. The preset model may include a backbone network shared by multiple tasks and a respective independent branch network for each task. The shared features of the original image can be extracted through the backbone network; The shared features can be input into each task-independent branch network to output the prediction results for each task separately.

The at least one prediction task may include a key point prediction task. The key point prediction task can refer to the task of predicting the key point position from the original image. Different types of original images have different key points to be predicted. For example, the key points to be predicted in the hand image can include finger nodes, and the key points to be predicted in the limb image can include joint points, etc.

In the training process of the preset model, sample images of the same category as the original image can be input into the preset model, and the prediction results of at least one prediction task for the sample image can be output through the preset model. According to the prediction results of each task and the truth tag of each task, the loss item of each task can be determined, so that the preset model can be trained based on the loss item of at least one task. For example, the backbone network in the preset model may be trained based on the loss item of at least one task.

If at least one prediction task includes a key point prediction task, the prediction result of the key point prediction task for the sample image may be referred to as the first prediction result. The loss item of the preset model in the training process may include the first loss constructed according to the error distribution between the first prediction result of the key point prediction task and the key point position label.

The distribution of variables around the true value (which can be called probability distribution) can affect the loss function used. For example, if the variable is Gaussian distribution, the corresponding loss function is mean square error; if the variable is Laplace distribution, the corresponding loss function is absolute error, etc. Among them, probability distribution and loss function can be linked by likelihood estimation. For example, the mean square error is the loss function obtained by maximum likelihood estimation of the Gaussian distribution of variables.

In this embodiment, the error distribution between the first prediction result and the key point position label can be considered as the probability distribution of the first prediction result around the real key point, and the real error distribution can be expressed by the distribution function. The error between the first prediction result and the key point position label can be used as sample data. Based on the sample data, the distribution function can be approximated by neural network, or by mathematical modeling. After determining the error distribution between the first prediction result and the key point position label, the loss function can be obtained by likelihood estimation of the error distribution, that is, the first loss.

In the related art, the mean square error between the predicted coordinates and the truth label is often used as the loss term in the prediction of key point position for model training. In this way, the default prediction key points obey Gaussian distribution around the real value. However, due to the different distribution of key points around the real value in different types of images, using the existing loss to carry out regression training on the model, the training effect can not be guaranteed, and it is prone to joint training failure.

By contrast, in the embodiments of the present disclosure, by determining the real error distribution between the first prediction result and the key point position label, an appropriate loss function can be constructed to help model parameters learn efficiently and accurately. This can not only optimize the prediction effect of key point position, but also make the joint training of multi-tasks achieve better results. Through multi-task joint training, the preset model is obtained, which can perform multi-task prediction. Compared with multi-task prediction based on multiple models, the preset model can not only align the effects of individual models for each task, but also reduce the number of models to one, so as to reduce the reasoning time.

According to the technical solution of the embodiments of the disclosure, the original image is input into a preset model; a prediction result of at least one prediction task for the original image is output through a preset model; the at least one prediction task comprises a key point prediction task, and wherein the loss item of the predetermined model in the training process comprises a first loss constructed based on an error distribution between the first prediction result of the key point prediction task and the key point position label. By constructing the loss item according to the real error distribution of the key points, the loss item can be constructed more reasonably, so as to realize the multi-task joint training including the prediction task of the key points. The training effect is good, and the accuracy of the multi-task prediction can be guaranteed.

The embodiments of the present disclosure may be combined with the optional solution in the method of multi-task prediction provided in the foregoing embodiments. The multi-task prediction method provided by this embodiment describes in detail the construction steps of the first loss in the training process of the preset model. By constructing the flow model according to the first prediction result, the real error distribution can be obtained by fitting the key points with the flow model. The first loss can be quickly obtained by residual likelihood estimation of error distribution.

FIG. 2 is a schematic flowchart of a training step of a preset model in a method of multi-task prediction according to embodiments of the present disclosure. As shown in FIG. 2, a training step of a preset model in a method of multi-task prediction may include:

S210: Input sample image into predetermined model

The sample image belongs to the same category as the original image.

S220: Output prediction result for at least one prediction task of sample image by predetermined model.

At least one prediction task may include a key point prediction task, and the prediction result of the key point prediction task may be referred to as the first prediction result.

S230: Construct flow model based on first prediction result and key point location position label.

The goal of building a flow based generic model is to train a generator. The generator can convert samples in a simple distribution π(z) into samples x=G(z) in complex distribution p_{G}(x). In this embodiment, the simple distribution π(z) can be, for example, Gaussian distribution, Laplace distribution, etc., and the complex distribution p_{G}(x) may refer to the distribution of the error between the first prediction result and the key point position label. By learning the mapping relationship between the simple distribution and the sampling value of the error, the flow model can be constructed.

S240: Determine error distribution between first prediction result and key point position label based on constructed flow model.

After determining the flow model of the mapping relationship from simple distribution to complex distribution, the simple distribution can be substituted into the flow model to obtain the error distribution between the first prediction result and the key point position label.

In some optional implementations, the convection model is constructed according to the first prediction result and the key point location label, including: sampling the error between the first prediction result and the key point location label and the first preset distribution to obtain the first sample and the second sample respectively; The flow model is constructed according to the first sample and the second sample.

The first preset distribution can be considered as a simple distribution. The first sample xᵢ and the second sample zᵢ can be obtained by sampling the error between the first prediction result and the key point position label, as well as the value in the first preset distribution. According to the reversibility of the flow model, the corresponding relationship between the first sample and the second sample can be represented by Formula 1: p_{G}(xᵢ)=π(zᵢ)|det(J_{G}_{^{−1}})|, where p_{G}(⋅) represents the complex distribution, π(⋅) represents the simple distribution, det (J) represents Jacobian determinant, G⁻¹ is the inverse of the flow model. The flow model can be built according to Formula 1, the first sample and the second sample.

In some implementations, the first sample and the second sample may be sampled circularly. Constructing a flow model according to the first sample and the second sample can include: determining the initial flow model according to the first sample and the second sample in a cycle; The initial flow model is updated iteratively until the likelihood estimation of the initial flow model meets the preset conditions.

G⁻¹ can be obtained by substituting the first and second samples collected each time into Formula 1, and the initial flow model can be obtained by inverse operation of G⁻¹. The likelihood estimation of the initial flow model meets the preset conditions, including that the likelihood estimation of the initial flow model meets the maximum likelihood estimation. By adjusting the parameters of the model, the initial flow model can maximize the probability of the first sample, that is, it meets the maximum likelihood estimation function

$${G}^{*} = arg {max}_{G} {\sum }_{j = 1}^{m} log {p}_{G} ( {x}_{j} ) ,$$

and the final flow model can be obtained.

Correspondingly, the first preset distribution can be input into the constructed flow model, and the error distribution between the first prediction result and the key point position label can be output through the constructed flow model.

S250: Perform log-likelihood estimation of residual between error distribution and second predetermined distribution to use obtained residual likelihood estimation loss as first loss.

In some other implementations, in addition to the log likelihood estimation of the residuals of the error distribution and the second preset distribution, the likelihood estimation of the error distribution can also be directly performed to obtain the first loss. However, this method will cause the regression efficiency of the prediction model to be slightly slow.

In this embodiment, to improve the regression efficiency of the model, log likelihood estimation can be selected for the residuals of the error distribution and the second preset distribution (such as Gaussian distribution), and a correction term can be introduced to make the residual process true. For example, the above residual ε(x) can be expressed as:

$$ε ( x ) = N ( 0 , 1 ) \cdot \frac{{p}_{G} ( x )}{s \cdot N ( 0 , 1 )} \cdot s ,$$

Where, p_{G}(⋅) is the error distribution; N (0, 1) is a simple Gaussian distribution, that is, the second preset distribution; s is a correction term.

The likelihood function can be obtained by taking the logarithm of the residuals:

$$log ε ( x ) = log N ( 0 , 1 ) + log \frac{{p}_{G} ( x )}{s \cdot N ( 0 , 1 )} + log s$$

Residual log likelihood estimation loss (RLE loss) can be determined according to the right part of the likelihood function equation, and RLE loss can be regarded as the first loss. For example, the first loss can be expressed as:

Lₖₚₜ=−log Q_{z}(\hat{z})−log G_{z}(\hat{z})+log σ,
where Q_{z}(\hat{z}) is a simple second preset distribution; G_{z}(\hat{z}) is quotient of error distribution and second preset distribution; and log σ is a correction term. Through the combination of the first two items, the model can be quickly regressed under the condition that the second preset distribution is fixed.

S260: Train the predetermined model based on the first loss.

In this embodiment, the backbone network of the preset model can be trained according to the first loss to optimize the prediction effect of other multi-tasks.

The technical solution of the embodiment of the disclosure describes in detail the construction steps of the first loss in the training process of the preset model. By constructing the flow model according to the first prediction result, the real error distribution of key points can be fitted by the flow model. The first error can be quickly obtained by residual likelihood estimation of the error distribution. The multi-task prediction method provided by the embodiment of the present disclosure belongs to the same concept as the multi-task prediction method provided by the above embodiment. The technical details not described in detail in this embodiment can be seen in the above embodiment, and the same technical features have the same effect in this embodiment and the above embodiment.

The embodiment of the present disclosure can be combined with the optional scheme in the multi-task prediction method provided in the above embodiment. In the multi-task prediction method provided by this embodiment, the preset model can be applied to the multi-task prediction of hand images. At least one task can include at least one of the hand gesture recognition task and the left and right hand classification task in addition to the hand key point prediction task. By using the real error distribution of the key points of the hand to construct the loss item, not only can the prediction effect of the model for the key points of the hand be optimized, but also the model can achieve better results in the multi-task learning of at least one of the gesture recognition task and the left and right hand classification task.

In some optional implementations, if the key point prediction task is a prediction task of a key point of a hand, the at least one task further comprises a left and right hand classification task. The loss item of the predetermined model in the training process further comprises: a third loss constructed based on a third prediction result of the left and right hand classification task and a left and right hand classification label.

In these optional implementations, the hand image can be input into the preset model to make the preset model output the prediction results of the hand key prediction task and the gesture classification task. The prediction result of the hand key point prediction task can include the position coordinates of at least one finger node of the hand; The prediction results of gesture classification tasks can include gesture classification such as finger comparison “V”, “OK” or “five fingers open”.

During the training of the preset model, the sample image of the hand can be input into the preset model, and the first prediction result of the key point prediction task of the hand and the second prediction result of the gesture classification task can be output through the preset model. The first loss that can be constructed according to the error distribution between the first prediction result and the key point position label, and the second loss that can be constructed according to the second prediction result and the gesture classification label (e.g., cross entropy loss).

For example, the second loss may be expressed as: L_{gesture}=CE(y_{gesture}, ŷ_{gesture}); where y_{gesture} is the second prediction result, ŷ_{gesture} is the gesture classification label and CE(⋅) is the cross entropy loss function. Further, the preset model may be trained according to the first loss and the second loss.

In some optional implementations, if the key point prediction task is a prediction task of a key point of a hand, the at least one task further comprises a left and right hand classification task. The loss item of the predetermined model in the training process further comprises: a third loss constructed based on a third prediction result of the left and right hand classification task and a left and right hand classification label.

In these optional implementations, the hand image can be input into the preset model to make the preset model output the prediction results of the hand key point prediction task and the left and right hand classification task. The prediction results of left-handed and right-handed classification tasks can include left-handed and right-handed classification.

During the training of the preset model, the sample image of the hand can be input into the preset model, and the first prediction result of the key point prediction task of the hand and the third prediction result of the left and right hand classification task can be output through the preset model. The first loss can be constructed according to the error distribution between the first prediction result and the key point position label, and the third loss can be constructed according to the third prediction result and the left and right hand classification label (for example, it can also be the cross entropy loss).

For example, the third loss may be expressed as: Lₗᵣ=CE(yₗᵣ, ŷₗᵣ); where yₗᵣ is the third prediction result, ŷₗᵣ is the left and right hand classification label and CE(⋅) is the cross entropy loss function. Further, the preset model may be trained according to the first loss and the third loss.

It can be understood that when at least one task includes a hand key prediction task, at least one task can also include at least one of a gesture recognition task and a left-right hand classification task. Accordingly, in addition to training the preset model with the first loss, the preset model can also be trained with at least one of the second loss and the third loss. In addition, other prediction tasks based on hand images can also be implemented based on the preset model disclosed in this embodiment, which is not exhaustive here.

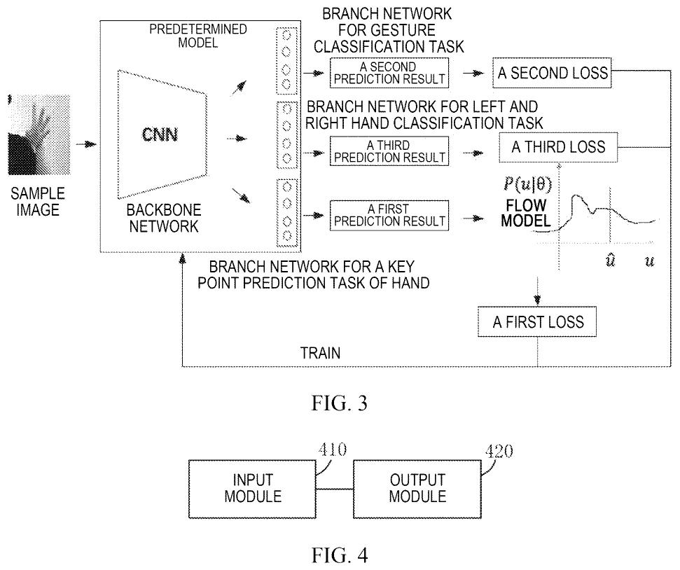

For example, FIG. 3 is a schematic block diagram of a preset model training step in a method of multi-task prediction according to embodiments of the present disclosure. The reference now is made to FIG. 3, After the sample image of the hand is input into the preset model, the image features can be extracted through the multi-task shared backbone network in the preset model. For example, the backbone network can be convolutional neural networks (CNN) or other feature extraction networks. Among them, the features of the extracted sample image can be input into the independent branch network of multiple tasks to output the prediction results of multiple tasks respectively.

The prediction result of the hand key point prediction task can be called the first prediction result; The prediction result of the gesture classification task can be called the second prediction result; The prediction results of left-handed and right-handed classification tasks can be called the third prediction results. Among them, the convection model can be constructed according to the first prediction result and the key point location label; According to the constructed flow model, determine the error distribution between the first prediction result and the key point position label, as shown in the figure; Log likelihood estimation is performed on the residuals of the error distribution and the second preset distribution, and the resulting likelihood estimation loss of the residuals is taken as the first loss. The second loss can also be constructed according to the second prediction result and the gesture classification label. The third loss can also be constructed according to the third prediction result and the left-hand and right-hand classification labels.

The total loss function may be formed from the first loss, the second loss, and the third loss. For example, the total loss function may be expressed as: L=α×L_{gesture}+β×Lₗᵣ+γ×Lₖₚₜ; where Lₖₚₜ is the first loss, L_{gesture} is the second loss and Lₗᵣ is the third loss, α [symbol] β [symbol] γ represent loss weight respectively. Thus, the preset model can be trained through the total loss function. Through the joint training of hand key point prediction task, gesture recognition task and left and right hand classification task, the three models of tasks can be reduced to one model, which can reduce the reasoning time and maintain the original independent model effect.

In some optional implementations, after outputting the prediction result of at least one prediction task for the original image through the preset model, it can also include: generating a gesture control instruction according to the prediction result of at least one prediction task, so that the target application program can execute the corresponding action in response to the gesture control instruction.

In these alternative implementations, the preset model can be applied to on-terminal gesture recognition. The hand image can be collected in response to the acquisition command input by the user, and at least one prediction result for the hand image can be output through the preset model. Further, a gesture control instruction can be generated according to the prediction result to enable the target application on the end to execute the corresponding action. The target application can refer to the program corresponding to the gesture control instruction. For example, when the preset result includes the gesture classification of “five fingers open” and the position of the key points of the hand, the gesture control command can be a confirmation command; Accordingly, the target application program can receive the confirmation instruction and execute the corresponding subsequent program.

In the technical solution of the embodiments of the present disclosure, the preset model can be applied to the multi task prediction of hand images. At least one task can include at least one of the hand gesture recognition task and the left and right hand classification task in addition to the hand key point prediction task. By using the real error distribution of the hand key points to construct the loss item, not only the prediction effect of the model for the hand key points can be optimized, but also the model can achieve better results in the multi task learning of gesture recognition task and left and right hand classification task. The multi task prediction method provided by the embodiment of the present disclosure belongs to the same concept as the multi task prediction method provided by the above embodiment. The technical details not described in detail in this embodiment can be seen in the above embodiment, and the same technical features have the same effect in this embodiment and the above embodiment.

FIG. 4 is a schematic structural diagram of an apparatus for multi-task prediction according to embodiments of the present disclosure. The embodiment of the disclosure is suitable for the situation that the image is subjected to multi-task prediction through a preset model, wherein the multi-task comprises a key point prediction task, and the preset model is obtained through training based on the real error distribution of the key point prediction task.

As shown in FIG. 4, an apparatus for multi-task prediction according to embodiments of the present disclosure may include:

An input module 410, configured to input the original image into a predetermined model.

An output module 420, configured to output a prediction result for at least one prediction task of the original image by the predetermined model;

The at least one prediction task comprises a key point prediction task, and wherein the loss item of the predetermined model in the training process comprises a first loss constructed based on an error distribution between the first prediction result of the key point prediction task and the key point position label.

In some optional implementations, the apparatus for multi-task prediction may further include:

A loss construction module is configured to determine an error distribution between the first prediction result and the key point location label by:
constructing a flow model based on the first prediction result and the key point position label;
determining an error distribution between the first prediction result and the key point position label based on the constructed flow model.

In some optional implementations, the loss construction module may be set as:
obtaining a first sample and a second sample respectively by sampling a first predetermined distribution and an error between the first prediction result and the key point position label;
constructing a flow model based on the first and the second samples.

In some optional implementations, the loss construction module may be set as:
determining an initial flow model based on the first and the second samples iteratively;
obtaining the flow model by iteratively updating the initial flow model until the likelihood estimation of the initial flow model meets a predetermined condition.

In some optional implementations, the loss construction module may be further configured to construct the first loss by:
performing a log-likelihood estimation of a residual between the error distribution and a second predetermined distribution, to use an obtained residual likelihood estimation loss as the first loss.

In some optional implementations, if the key point prediction task is a prediction task of a key point of a hand, the at least one task further comprises a gesture classification task.

The loss item of the predetermined model in the training process further comprises: a second loss constructed based on a second prediction result of the gesture classification task and a gesture classification label.

In some optional implementations, if the key point prediction task is a prediction task of a key point of a hand, the at least one task further comprises a left and right hand classification task.

The loss item of the predetermined model in the training process further comprises: a third loss constructed based on a third prediction result of the left and right hand classification task and a left and right hand classification label

In some optional implementations, the apparatus of multi-task prediction further includes:

A control module is configured to, after the outputting a prediction result for at least one prediction task of the original image by using a predetermined model, generate a gesture control instruction based on a prediction result of the at least one prediction task, to cause the target application to perform a corresponding action based on the gesture control instruction.

The apparatus of multi-task prediction provided by the embodiments of the present disclosure may perform the method of multi-task prediction provided by any embodiment of the present disclosure, and has corresponding function modules and effects of the execution method.

It should be noted that the units and modules included in the foregoing apparatus are only divided according to the function logic, but are not limited to the foregoing division, as long as the corresponding functions can be implemented; in addition, names of the function units are merely for ease of distinguishing, and are not used to limit the protection scope of the embodiments of the present disclosure.

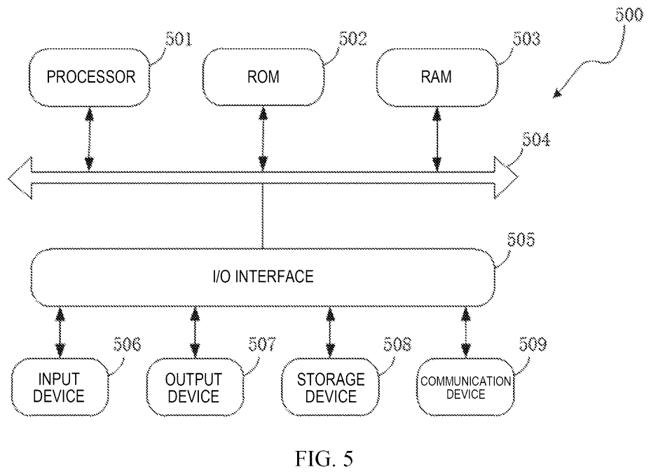

Referring to FIG. 5, FIG. 5 is a schematic structural diagram of an electronic device (such as the terminal device or server in FIG. 5) suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 5 is merely an example, and should not impose any limitation on the functions and scope of use of the embodiments of the present disclosure.

As shown in FIG. 5, the electronic device 500 may include a processor (for example, a central processing unit, a graphics processor, etc.) 501, and the processor 501 may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processor 501, the ROM 502, and the RAM 503 are connected to each other through a bus 504. Input/output (I/O) interface 505 is also connected to bus 504.

Generally, the following devices may be connected to the I/O interface 505: an input device 506 including, for example, a touch screen, a touch pad, a keyboard, a mouse, a camera, a microphone, an accelerometer, a gyroscope, etc.; an output device 507 including, for example, a liquid crystal display (LCD), a speaker, a vibrator, etc.; a storage device 508 including, for example, a magnetic tape, a hard disk, etc.; and a communication device 509. The communication device 509 may allow the electronic device 500 to communicate wirelessly or wired with other devices to exchange data. While FIG. 5 shows an electronic device 500 having various devices, it should be understood that it is not required to implement or have all illustrated devices. More or fewer devices may alternatively be implemented or provided.

In particular, according to embodiments of the present disclosure, the process described above with reference to the flowchart may be implemented as a computer software program. For example, embodiments of the present disclosure include a computer program product comprising a computer program embodied on a non-transitory computer readable medium, the computer program comprising program code for performing the method shown in the flowchart. In such embodiments, the computer program may be downloaded and installed from the network through the communication device 509, or installed from the storage device 508, or installed from ROM 502. When the computer program is executed by the processor 501, the foregoing functions defined in the method of multi-task prediction of the embodiments of the present disclosure are performed.

The electronic device provided by the embodiments of the present disclosure and the method of multi-task prediction provided in the foregoing embodiments belong to the same concept, technical details not described in detail in this embodiment may refer to the foregoing embodiments, and this embodiment has the same effect as the foregoing embodiments.

Embodiments of the present disclosure provides a computer-readable storage medium having a computer program stored thereon, the program, when executed by a processor, implements the method of multi-task prediction provided in the foregoing embodiments.

It should be noted that the computer-readable storage medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. Examples of the computer-readable storage medium may include, but are not limited to, an electrical connection having at least one wire, a portable computer diskette, a hard disk, a random access memory (RAM), a read-only memory (ROM), an erasable programmable read-only memory (EPROM) or a flash memory (FLASH), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable storage medium other than a computer readable storage medium that may send, propagate, or transmit a program for use by or in connection with an instruction execution system, apparatus, or device. The program code embodied on the computer-readable storage medium may be transmitted by any suitable medium, including but not limited to: wires, optical cables, Radio Frequency (RF), and the like, or any suitable combination thereof.

In some implementations, the client, server may communicate using any currently known or future developed network protocol, such as Hyper Text Transfer Protocol (HTTP), and may be interconnected with any form or medium of digital data communication (e.g., a communication network). Examples of communication networks include Local Area Networks (LANs), Wide Area Networks (WANs), Internet networks (e.g., the Internet), and peer-to-peer networks (e.g., ad hoc peer-to-peer networks), as well as any currently known or future developed networks.

The computer-readable storage medium described above may be included in the foregoing electronic device; or may exist alone or in the electronic device.

The computer-readable storage medium carries at least one program, and when the at least one program is executed by the electronic device, the electronic device is caused to:
inputting an original image into a predetermined model; outputting a prediction result for at least one prediction task of the original image by the predetermined model; the at least one prediction task comprises a key point prediction task, and wherein the loss item of the predetermined model in the training process comprises a first loss constructed based on an error distribution between the first prediction result of the key point prediction task and the key point position label.

Computer program code for performing the operations of the present disclosure may be written in at least one programming language, including, but not limited to, an object-oriented programming language such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes at least one executable instruction for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and flowcharts, as well as combinations of blocks in the block diagrams and flowcharts, may be implemented with dedicated hardware-based system that perform specified functions or operations, or may be implemented in a combination of dedicated hardware and computer instructions.

The units involved in the embodiments of the present disclosure may be implemented in software, or may be implemented in hardware. The names of the units and modules do not constitute a limitation on the unit and the module itself.

The functions described above may be performed, at least in part, by at least one hardware logic component. For example, without limitation, the exemplary types of hardware logic components that may be used include: a Field Programmable Gate Array (FPGA), an Application Specific Integrated Circuit (ASIC), an Application Specific Standard (ASSP), a System on Chip (SOC), a Complex Programmable Logic Device (CPLD), or the like.

In the context of the present disclosure, a machine-readable storage medium may be a tangible medium that may contain or store a program for use by or in connection with an instruction execution system, apparatus, or device. The machine-readable storage medium may be a machine-readable signal medium or a machine-readable storage medium. The machine-readable storage medium may include, but is not limited to, electronic, magnetic, optical, electromagnetic, infrared, or semiconductor systems, devices, or devices, or any suitable combination of the foregoing. Examples of machine-readable storage media include an electrical connection based on at least one line, a portable computer disk, a hard disk, a random access memory (RAM), a read-only memory (ROM), an erasable programmable read-only memory (EPROM), a flash memory, an optical fiber, a portable compact disk read-only memory (CD-ROM), an optical storage device, a magnetic storage device, or any suitable combination of the foregoing.

According to one or more embodiments of the present disclosure, a method of multi-task prediction (example 1) is provided, including:
inputting an original image into a predetermined model;
outputting a prediction result for at least one prediction task of the original image by the predetermined model;
The at least one prediction task comprises a key point prediction task; the loss item of the preset model in the training process comprises a first loss constructed according to the error distribution between the first prediction result of the key point prediction task and the key point position label

According to one or more embodiments of the present disclosure, there is provided a method of multi-task prediction (example 2), further comprising:

In some optional implementations, the error distribution between the first prediction result and the key point location label is determined by:
constructing a flow model based on the first prediction result and the key point position label;
determining an error distribution between the first prediction result and the key point position label based on the constructed flow model.

According to one or more embodiments of the present disclosure, there is provided a method of multi-task prediction (example 3), further comprising:

In some optional implementations, the constructing a flow model based on the first prediction result and the key point position label comprises:
obtaining a first sample and a second sample respectively by sampling a first predetermined distribution and an error between the first prediction result and the key point position label;
constructing a flow model based on the first and the second samples.

According to one or more embodiments of the present disclosure, there is provided a method of multi-task prediction (example 4), further comprising:

In some optional implementations, the constructing a flow model based on the first and the second samples comprises:
determining an initial flow model based on the first and the second samples iteratively;
obtaining the flow model by iteratively updating the initial flow model until the likelihood estimation of the initial flow model meets a predetermined condition.

According to one or more embodiments of the present disclosure, there is provided a method of multi-task prediction (example 5), further comprising:

In some optional implementations, the first loss is constructed by:
performing a log-likelihood estimation of a residual between the error distribution and a second predetermined distribution, to use an obtained residual likelihood estimation loss as the first loss.

According to one or more embodiments of the present disclosure, there is provided a method of multi-task prediction (example 6), further comprising:

In some optional implementations, when if the key point prediction task is a prediction task of a key point of a hand, the at least one task further comprises a gesture classification task.

The loss item of the predetermined model in the training process further comprises: a second loss constructed based on a second prediction result of the gesture classification task and a gesture classification label.

According to one or more embodiments of the present disclosure, there is provided a method of multi-task prediction (example 7), further comprising:

In some optional implementations, if the key point prediction task is a prediction task of a key point of a hand, the at least one task further comprises a left and right hand classification task.

The loss item of the predetermined model in the training process further comprises: a third loss constructed based on a third prediction result of the left and right hand classification task and a left and right hand classification label.

According to one or more embodiments of the present disclosure, there is provided a method of multi-task prediction (example 8), further comprising:

In some optional implementations, after the outputting a prediction result for at least one prediction task of the original image by using a predetermined model, the method further comprises:
generating a gesture control instruction based on a prediction result of the at least one prediction task, to cause the target application to perform a corresponding action based on the gesture control instruction.

According to one or more embodiments of the present disclosure, there is provided an apparatus for multi-task prediction (example 9), comprising:

An input module configured to input the original image into a predetermined model.

An output module configured to output a prediction result for at least one prediction task of the original image by the predetermined model;

The at least one prediction task comprises a key point prediction task, and wherein the loss item of the predetermined model in the training process comprises a first loss constructed based on an error distribution between the first prediction result of the key point prediction task and the key point position label.

1-11. (canceled)

12. A method of multi-task prediction comprising:
inputting an original image into a predetermined model;
outputting a prediction result for at least one prediction task of the original image by the predetermined model;
wherein the at least one prediction task comprises a key point prediction task, and wherein a loss item of the predetermined model in a training process comprises a first loss constructed based on an error distribution between the first prediction result of the key point prediction task and a key point position label.

13. The method of claim 12, wherein the error distribution between the first prediction result and the key point position label is determined by:
constructing a flow model based on the first prediction result and the key point position label;
determining an error distribution between the first prediction result and the key point position label based on the constructed flow model.

14. The method of claim 13, wherein the constructing a flow model based on the first prediction result and the key point position label comprises:
obtaining a first sample and a second sample respectively by sampling a first predetermined distribution and an error between the first prediction result and the key point position label;
constructing a flow model based on the first and the second samples.

15. The method of claim 14, wherein the constructing a flow model based on the first and the second samples comprises:
determining an initial flow model based on the first and the second samples iteratively;
obtaining the flow model by iteratively updating the initial flow model until a likelihood estimation of the initial flow model meets a predetermined condition.

16. The method of claim 12, wherein the first loss is constructed by:
performing a log-likelihood estimation of a residual between the error distribution and a second predetermined distribution, to use an obtained residual likelihood estimation loss as the first loss.

17. The method of claim 12, wherein if the key point prediction task is a prediction task of a key point of a hand, the at least one task further comprises a gesture classification task; and wherein
the loss item of the predetermined model in the training process further comprises: a second loss constructed based on a second prediction result of the gesture classification task and a gesture classification label.

18. The method of claim 12, wherein if the key point prediction task is a prediction task of a key point of a hand, the at least one task further comprises a left and right hand classification task; and wherein
the loss item of the predetermined model in the training process further comprises: a third loss constructed based on a third prediction result of the left and right hand classification task and a left and right hand classification label.

19. The method of any of claim 17, wherein after the outputting a prediction result for at least one prediction task of the original image by using a predetermined model, the method further comprises:
generating a gesture control instruction based on a prediction result of the at least one prediction task, to cause a target application to perform a corresponding action based on the gesture control instruction.

20. An electronic device, comprising:
at least one processor;
a storage device, configured to store at least one program;
when the at least one program is executed by the at least one processor, cause the at least one processor to implement a method comprising:
inputting an original image into a predetermined model;
outputting a prediction result for at least one prediction task of the original image by the predetermined model;
wherein the at least one prediction task comprises a key point prediction task, and wherein a loss item of the predetermined model in a training process comprises a first loss constructed based on an error distribution between the first prediction result of the key point prediction task and a key point position label.

21. The device of claim 20, wherein the error distribution between the first prediction result and the key point position label is determined by:
constructing a flow model based on the first prediction result and the key point position label;
determining an error distribution between the first prediction result and the key point position label based on the constructed flow model.

22. The device of claim 21, wherein the constructing a flow model based on the first prediction result and the key point position label comprises:
obtaining a first sample and a second sample respectively by sampling a first predetermined distribution and an error between the first prediction result and the key point position label;
constructing a flow model based on the first and the second samples.

23. The device of claim 22, wherein the constructing a flow model based on the first and the second samples comprises:
determining an initial flow model based on the first and the second samples iteratively;
obtaining the flow model by iteratively updating the initial flow model until a likelihood estimation of the initial flow model meets a predetermined condition.

24. The device of claim 20, wherein the first loss is constructed by:
performing a log-likelihood estimation of a residual between the error distribution and a second predetermined distribution, to use an obtained residual likelihood estimation loss as the first loss.

25. The device of claim 20, wherein if the key point prediction task is a prediction task of a key point of a hand, the at least one task further comprises a gesture classification task; and wherein
the loss item of the predetermined model in the training process further comprises: a second loss constructed based on a second prediction result of the gesture classification task and a gesture classification label.

26. The device of claim 20, wherein if the key point prediction task is a prediction task of a key point of a hand, the at least one task further comprises a left and right hand classification task; and wherein
the loss item of the predetermined model in the training process further comprises: a third loss constructed based on a third prediction result of the left and right hand classification task and a left and right hand classification label.

27. The device of claim 25, wherein after the outputting a prediction result for at least one prediction task of the original image by using a predetermined model, the method further comprises:
generating a gesture control instruction based on a prediction result of the at least one prediction task, to cause a target application to perform a corresponding action based on the gesture control instruction.

28. The device of claim 26, wherein after the outputting a prediction result for at least one prediction task of the original image by using a predetermined model, the method further comprises:
generating a gesture control instruction based on a prediction result of the at least one prediction task, to cause a target application to perform a corresponding action based on the gesture control instruction.

29. A non-transitory readable storage medium comprising a computer program,
wherein the computer program, when executed by a computer processor, performs a method comprising:
inputting an original image into a predetermined model;
outputting a prediction result for at least one prediction task of the original image by the predetermined model;
wherein the at least one prediction task comprises a key point prediction task, and wherein a loss item of the predetermined model in a training process comprises a first loss constructed based on an error distribution between the first prediction result of the key point prediction task and a key point position label.
